(19) United States
(12) Patent Application Publication
(10) Pub. No.: US 2004/0203333 A1
(43) Pub. Date: Oct. 14, 2004

(54) Defroster device for a vehicle

(76) Inventor: Dong Won Yeon, Hwaseong-city (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/628,722

(22) Filed: Jul. 28, 2003

(30) Foreign Application Priority Data
Apr. 14, 2003 (KR) 10-2003-0023375

(51) Int. Cl. B60S 1/54

(52) U.S. Cl. 454/121

(57) ABSTRACT

The defroster device that is capable of reducing a resistance of air flow is provided. The defroster device comprises an air conditioning unit, a front defroster nozzle, and a side defroster nozzle. The air conditioning unit has an air outlet that is divided into at least two portions. The front defroster nozzle has a first left nozzle and a first right nozzle that have air passageways respectively communicating with the divided portion of the air outlet of the air conditioning unit, and the side defroster nozzle has a second left nozzle and a second right nozzle that have air passageways respectively communicating with the divided portion of the air outlet of the air conditioning unit.

### FIELD OF THE INVENTION

The present invention relates to a defroster device that can be used in connection with an air conditioning system of a vehicle.

### BACKGROUND OF THE INVENTION

A layer of frost may be formed on an inner surface of a windshield or an inner surface of a side door glass of a vehicle because of a temperature difference between a passenger compartment and the outside of a vehicle. Such a frost layer may obstruct a driver's view, and it may cause an accident. For this reason, most vehicles are equipped with a defroster device for removing the frost layer from the windshield or the side door glass. Generally, the defrost device has a duct structure for directing conditioned air generated by an air conditioning unit (for example, a heater unit) toward a windshield or a side door glass.

The conventional defrost device includes a front defroster nozzle and a side defroster nozzle. The front defroster nozzle is configured to be supplied with conditioned air from the air conditioning unit and to direct the same toward a windshield, and the side defroster nozzle is configured to be supplied with conditioned air from the air conditioning unit and to direct the same toward a side door glass.

Generally, the side defroster nozzle is integrally formed with the front defroster nozzle, and the side and front defroster nozzles are respectively provided with air inlets through which conditioned air is supplied from the air conditioning unit.

In the conventional defroster nozzles, there is a problem in that substantial air resistance occurs while conditioned air is being supplied to the front and side defroster nozzles from the air conditioning unit. Furthermore, air resistance inside the side defroster nozzle is very high because a direction of air flow suddenly changes while air flows through the side defroster nozzle.

As an example, in a defroster nozzle disclosed in the U.S. Pat. No. 5,113,748, the direction of air flow suddenly changes (from a vertical direction to a lateral direction) in a side defroster nozzle so that there is strong resistance against air flow in the side defroster nozzle. Therefore, frost in the side door glass cannot be efficiently removed using such a conventional defroster device. Furthermore, conditioned air is not supplied into the front defroster nozzle and the side defroster nozzle uniformly, and thereby air resistance also increases.

Consequently, conventional defroster nozzles generally have at least a defect in that frost cannot be removed in a short time because of substantial air resistance.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

Embodiments of the present invention provide a defroster device that is capable of minimizing resistance of air flow supplied into front and side defroster nozzles from an air conditioning unit, and of minimizing resistance of air flow inside the side defroster nozzle by optimizing its shape.

In a preferred embodiment of the present invention, the defroster device for a vehicle comprises an air conditioning unit, a front defroster nozzle, and a side defroster nozzle. The air conditioning unit has an air outlet that is divided into at least two portions. The front defroster nozzle has a first left nozzle and a first right nozzle that have air passageways respectively communicating with the divided portion of the air outlet of the air conditioning unit. The side defroster nozzle has a second left nozzle and a second right nozzle that have air passageways respectively communicating with the divided portion of the air outlet of the air conditioning unit.

It is preferable that upstream portions of the second left nozzle and the second right nozzle of the side defroster nozzle are slanted at a predetermined angle.

In another preferred embodiment of the present invention, the defroster device for a vehicle comprises: an air conditioning unit provided with an air outlet divided into a first left air outlet, a first right air outlet, a second left air outlet, and a second right air outlet; a front defroster nozzle including a first left nozzle that communicates with the first left air outlet, and a first right nozzle that communicates with the first right air outlet; and a side defroster nozzle including a second left nozzle that communicates with the second left air outlet, and a second right nozzle that communicates with the second right air outlet.

It is preferable that the first left air outlet and the first right air outlet of the air conditioning unit have substantially the same size, and that the second left air outlet and the second right air outlet of the air conditioning unit have substantially the same size.

It is further preferable that upstream portions of the second left nozzle and the second right nozzle of the side defroster nozzle are respectively slanted at a predetermined angle.

### BRIEF DESCRIPTION OF THE DRAWINGS

The accompanying drawings, which are incorporated in and constitute a part of the specification, illustrate an embodiment of the invention, and, together with the description, serve to explain the principles of the invention, where:

FIG. 1 is a perspective view of a defroster device according to a predetermined embodiment of the present invention;

FIG. 2 shows an outlet portion of an air conditioning unit of FIG. 1;

FIG. 3 is a perspective view of a front defroster nozzle of the defroster device of FIG. 1;

FIG. 4 is a perspective view of a side defroster nozzle of the defroster device of FIG. 1;

FIG. 5 shows a coupling of the front defroster nozzle of FIG. 3 and the side defroster nozzle of FIG. 4; and

FIG. 6 shows performance for removing frost by the defroster device according to the prior art and by the defroster device according to the preferred embodiment of the present invention.

### DETAILED DESCRIPTION OF THE PREFERRED EMBODIMENTS

Hereinafter, a preferred embodiment of the present invention will be described in detail with reference to the accompanying drawings.

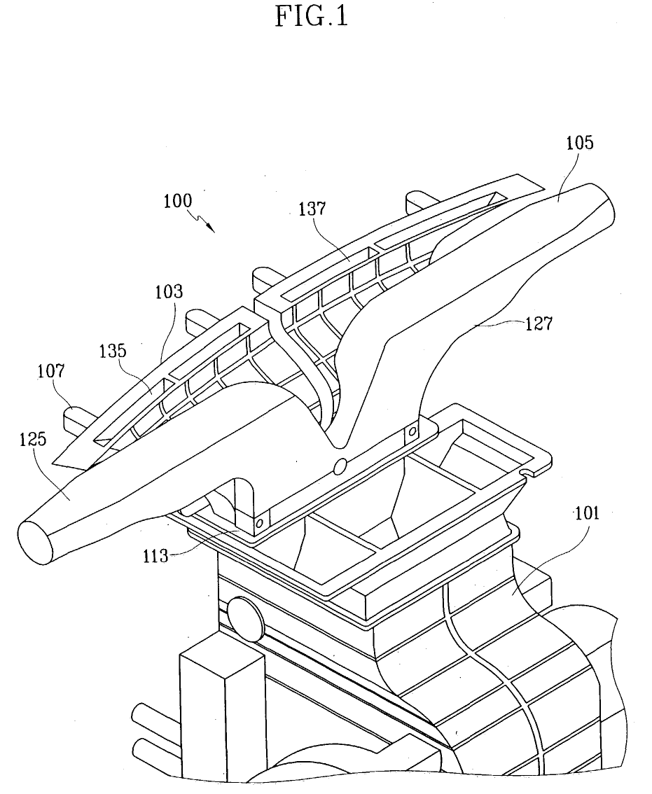

As shown in FIG. 1, a defroster device 100 according to the preferred embodiment of the present invention includes an air conditioning unit 101, a front defroster nozzle 103, and a side defroster nozzle 105. For example, the air conditioning unit 101 can be a heater.

The front defroster nozzle 103 is configured to be supplied with conditioned air (for example, heated air) from the air conditioning unit 101, and to direct the supplied air toward a front portion of a passenger compartment (toward a windshield). The side defroster nozzle 105 is configured to be supplied with conditioned air from the air conditioning unit 101 and to direct the supplied air toward a side portion of the passenger compartment (toward side door glass).

That is, conditioned air passing through the front defroster nozzle 103 is directed toward a windshield of a vehicle, and conditioned air passing through the side defroster nozzle 105 is directed toward a side door glass of a vehicle.

The front and side defroster nozzles 103 and 105 are respectively provided with an air passageway, and it is preferable that the side defroster nozzle is fixedly coupled to the front defroster nozzle 103. Further, it is preferable that the front and side defroster nozzles 103 and 105 are disposed behind an instrument panel (not shown) of a vehicle. The front defroster nozzle 103 is provided with one or more coupling brackets 107 for attachment to the instrument panel.

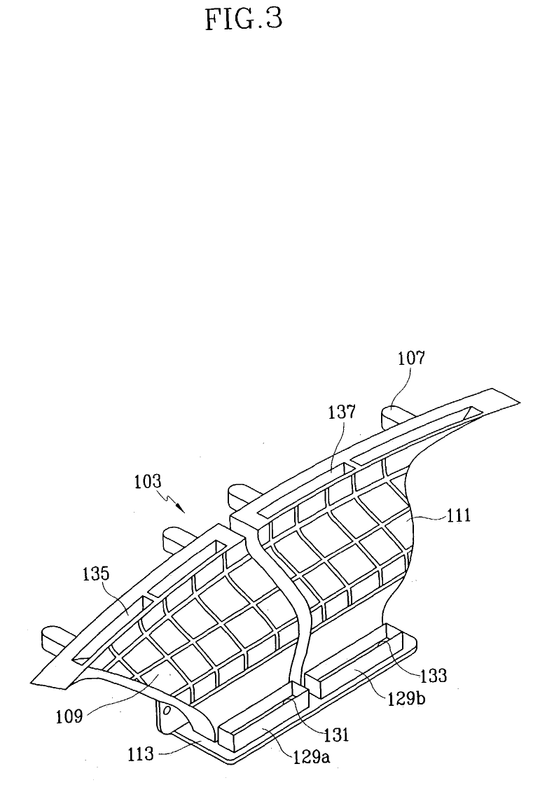

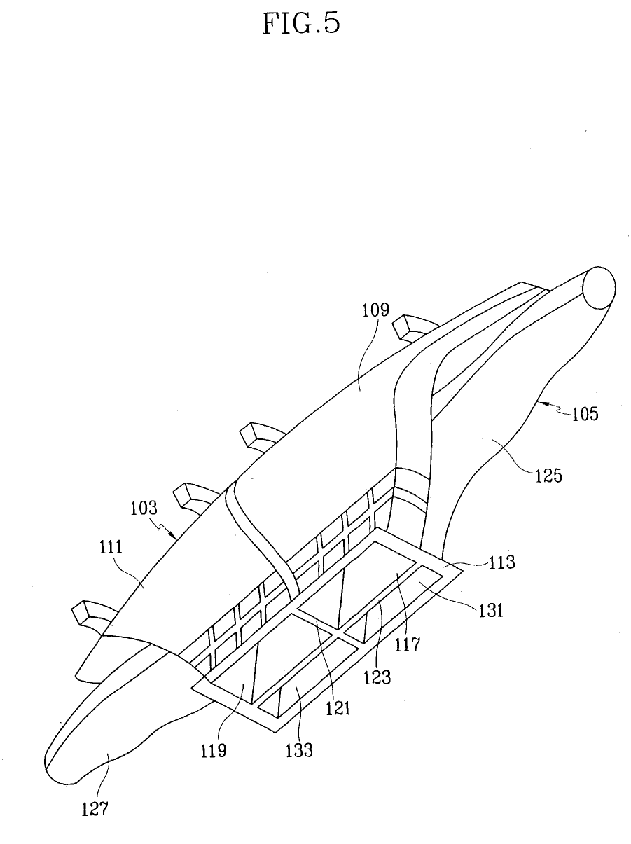

As shown in FIGS. 3 and 5, the front defroster nozzle 103 includes a left nozzle 109 for directing conditioned air toward a left portion of a windshield, and a right nozzle 111 for directing conditioned air toward a right portion of a windshield. It is preferable that the left and right nozzles 109 and 111 have separate air passageways.

The front defroster nozzle 103 is, as shown in FIG. 3, provided with a flange portion 113 at an inlet portion thereof, and the front defroster nozzle 103 is coupled to a flange portion 115 of the air conditioning unit 101 through the flange portion 113.

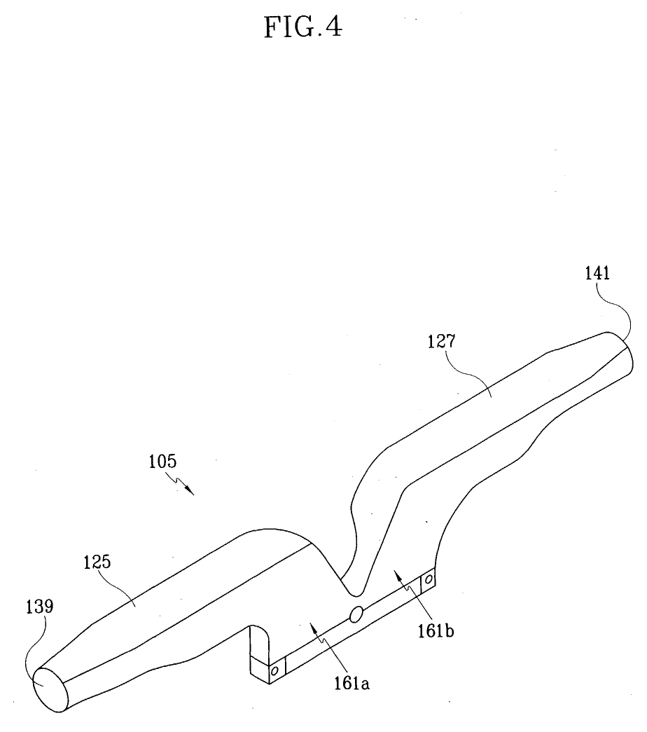

As shown in FIG. 4, the side defroster nozzle 105 includes a left nozzle 125 for directing conditioned air toward a left side door glass, and a right nozzle 127 for directing conditioned air toward a right side door glass.

The side defroster nozzle 105 is coupled to coupling portions 129a and 129b. However, it is also possible that the side defroster nozzle 105 is integrally formed with the front defroster nozzle 103.

Air inlets are provided in upstream portions of the left and right nozzles 125 and 127 of the side defroster nozzle 105. A left air outlet 139 is provided in a downstream portion of the left nozzle 125, and a right air outlet 141 is provided in a downstream portion of the right nozzle 127.

As shown in FIG. 5, an inlet portion of the front defroster nozzle 103 is divided into four separate portions by a first partitioning wall 121 and a second partitioning wall 123. That is, the inlet portion of the front defroster nozzle 103 is divided into a first left air inlet 117, a first right air inlet 119, a second left air inlet 131, and a second right air inlet 133. The first left air inlet 117 communicates with an air passageway of the left nozzle 109 of the front defroster nozzle 103, the first right air inlet 119 communicates with an air passageway of the right nozzle 111 of the front defroster nozzle 103, the second left air inlet 131 communicates with an air passageway of the left nozzle 25 of the side defroster nozzle 105, and the second right air inlet 133 communicates with an air passageway of the right nozzle 27 of the side defroster nozzle 105. As shown in FIG. 3; the second left air inlet 131 and the second right air inlet 133 are respectively formed in coupling portions 129a and 129b.

As shown in FIG. 5, it is preferable that the first left air inlet 117 and the first right air inlet 119 have the same size, and the second left air inlet 131 and the second right air inlet 133 have the same size.

If the sizes of the left and right air inlets are equal, the same amount of air is supplied to both directions so that the resistance of air flow can be minimized.

A first left air outlet 135 and a first right air outlet 137 are provided in an end portion of the front defroster nozzle 103. The first left air outlet 135 and the first right air outlet 137 are extended along a vehicle width direction. The first left air outlet 135 and the first right air outlet 137 can be respectively divided into more than two portions.

Therefore, as shown in FIG. 5, separate air passageways are formed in the front defroster nozzle 103 and the side defroster nozzle 105.

As shown in FIG. 1, the front defroster nozzle 103 is coupled on top of the air conditioning unit 101.

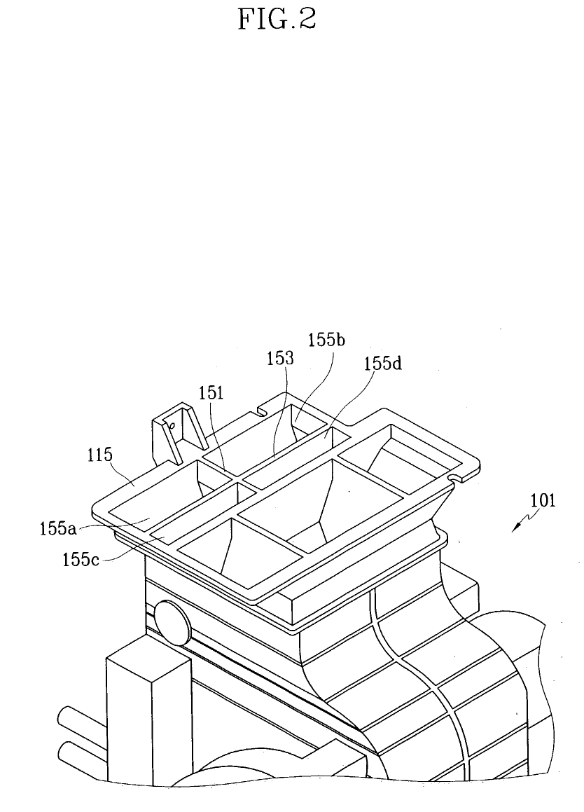

As shown in FIG. 2, an outlet portion of the air conditioning unit 101 is divided into four portions by a first partitioning wall 151 and a second partitioning wall 153. That is, the outlet portion of the air conditioning unit 101 is divided into a first left air outlet 115a, a first right air outlet 155b, a second left air outlet 115c, and a second right air outlet 155d.

If the front defroster nozzle 103 is coupled on the top of the air conditioning unit 101 and the side defroster nozzle 105 is coupled to the coupling portions 129a and 129b of the front defroster nozzle 103, four separate air passageways are formed.

That is, the first left air outlet 155a communicates with the first left air inlet 117 so that an air passageway in the left nozzle 109 of the front defroster nozzle 103 is formed, and the first right air outlet 155b communicates with the first right air inlet 119 of the front defroster nozzle 103 so that an air passageway in the right nozzle 111 of the front defroster nozzle 103 is formed.

Similarly, the second left air outlet 155c of the air conditioning unit 101 communicates with the second left air inlet 131 of the front defroster nozzle 103 so that an air passageway of the left nozzle 125 of the side defroster nozzle 105 is formed, and the second right air outlet 155d of the air conditioning unit 101 communicates with the second right air inlet 133 of the front defroster nozzle 103 so that an air passageway of the right nozzle 127 of the side defroster nozzle 105 is formed.

As shown in FIGS. 1 and 4, upstream portions of the left nozzle 125 and the right nozzle 127 of the side defroster nozzle 105 are slanted in opposite directions at a specific angle with respect to a vertical direction. By making an upstream portion of the left and right nozzles 125 and 127 slanted, a direction of air flow in the air passageway of the left and right nozzles 125 and 127 can be prevented from suddenly changing, so that resistance of air flow in the left and right nozzles 125 and 127 of the side defroster nozzle 105 can be decreased.

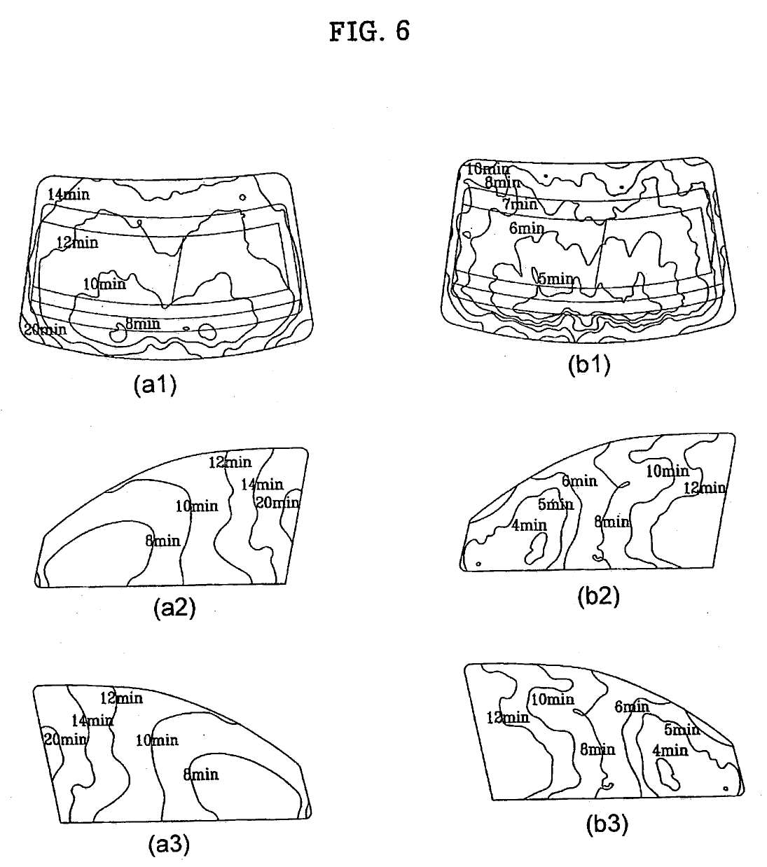

FIG. 6 shows comparative states of removal of frost according to a lapse of time when using defroster devices according to the prior art and an embodiment of the present invention.

FIG. 6 (a1), (a2), and (a3) show a boundary line of a frost layer remaining on a windshield, a left side door glass, and a right side door glass after conditioned air has been directed for certain time periods by the defroster device according to the prior art; and FIG. 6 (b1), (b2), and (b3) show a boundary line of a frost layer remaining on a windshield, a left side door glass, and a right side door glass, after conditioned air has been directed for certain time periods by the defroster device according to the embodiment of the present invention.

Referring to FIG. 6, it can be seen that the defroster device according to the preferred embodiment of the present invention can substantially reduce the time required for removing the frost layer. As stated in the above, in the defroster device according to the preferred embodiment of the present invention, the outlet portion of the air conditioning unit is divided into four portions, so that flow of conditioned air is separated in the outlet portion of the air conditioning portioning unit before conditioned air is supplied to the front and side defroster nozzles, and thereby resistance of air flow can be substantially reduced.

Further, the slanted portions are provided in the upstream portion of the side defroster nozzle, so that a sudden change of direction of air flow can be prevented, and thereby resistance of air flow can be substantially reduced.

Although preferred embodiments of the present invention have been described in detail hereinabove, it should be clearly understood that many variations and/or modifications of the basic inventive concepts herein taught which may appear to those skilled in the present art will still fall within the sprit and scope of the present invention, as defined in the appended claims.

Throughout this specification and the claims which follow, unless explicitly described to the contrary, the word “comprise” or variations such as “comprises” or “comprising” will be understood to imply the inclusion of stated elements but not the exclusion of any other elements.

1. A defroster device for a vehicle comprising:
an air conditioning unit having an air outlet that is divided into a front portion and a rear portion wherein said front portion is further divided into a front left air outlet and a front right air outlet and said rear portion is further divided into a rear left air outlet and a rear right air outlet;
a front defroster nozzle having a first left nozzle and a first right nozzle that have air passageways respectively communicating with a front divided portion of the air outlet of the air conditioning unit; and
a side defroster nozzle having a second left nozzle and a second right nozzle that have air passageways respectively communicating with a rear divided portion of the air outlet of the air conditioning unit.

2. The defroster device of claim 1, wherein upstream portions of the second left nozzle and the second right nozzle of the side defroster nozzle are slanted at a predetermined angle.

3. A defroster device for a vehicle comprising:
an air conditioning unit provided with an air outlet divided into a first left air outlet, a first right air outlet, a second left air outlet, and a second right air outlet;
a front defroster nozzle including a first left nozzle that communicates with the first left air outlet and a first right nozzle that communicates with the first right air outlet; and
a side defroster nozzle including a second left nozzle that communicates with the second left air outlet and a second right nozzle that communicates with the second right air outlet.

4. The defroster device of claim 3, wherein the first left air outlet and the first right air outlet of the air conditioning unit have substantially the same size.

5. The defroster device of claim 3, wherein the second left air outlet and the second right air outlet of the air conditioning unit have substantially the same size.

6. The defroster device of claim 3, wherein upstream portions of the second left nozzle and the second right nozzle of the side defroster nozzle are respectively slanted at a predetermined angle.
